(19) United States
(12) Patent Application Publication
(10) Pub. No.: US 2024/0329889 A1
(43) Pub. Date: Oct. 3, 2024

(54) INFORMATION PROCESSING SYSTEM, NON-TRANSITORY COMPUTER READABLE MEDIUM AND INFORMATION PROCESSING METHOD

(71) Applicant: FUJIFILM Business Innovation Corp., Tokyo (JP)

(72) Inventor: Akihiro Ishii, Kanagawa (JP)

(73) Assignee: FUJIFILM Business Innovation Corp., Tokyo (JP)

(21) Appl. No.: 18/456,518

(22) Filed: Aug. 27, 2023

(30) Foreign Application Priority Data
Mar. 27, 2023 (JP) 2023-049815

(51) Int. Cl. G06F 3/12; G06T 7/20

(52) U.S. Cl. CPC G06F 3/1204; G06F 3/1222; G06F 3/1238; G06F 3/1239; G06T 7/20; G06T 2207/30196; G06T 2207/30232

(57) ABSTRACT

An information processing system includes a processor configured to: acquire image information that is obtained by photographing a person; track a movement of the person using the acquired image information; and grant a person who has stayed within a specific region for a predetermined period of time or longer an authority to perform a specific operation on an information processing apparatus, the specific region being set in advance.

### CROSS-REFERENCE TO RELATED APPLICATIONS

This application is based on and claims priority under 35 USC 119 from Japanese Patent Application No. 2023-049815 filed Mar. 27, 2023.

### BACKGROUND

### (i) Technical Field

The present disclosure relates to an information processing system, a non-transitory computer readable medium and an information processing method.

### (ii) Related Art

Japanese Unexamined Patent Application Publication No. 2021-009454 discloses a store terminal apparatus that operates in a customer mode and an employee mode. A customer pays a price at any timing in the customer mode and the store terminal apparatus performs an operation related to employee jobs in the employee mode.

Unmanned payment store systems are currently being introduced in retail stores, such as convenience stores. A large number of cameras installed at a store keep track of a customer who has entered the store and recognize an item the customer is holding and the customer make a payment with the item held by the customer displayed on a payment device in a payment area. The payment method include cash, credit card, IC card or two-dimensional payment system.

An image forming apparatus installed in such an unmanned payment store operates in the employee mode that is used only by employees. Each store employee may perform a variety of settings and maintenance job. In order to use the employee mode in the image forming apparatus installed in the unmanned payment store, an employee may have to enter a password in an input device of the image forming apparatus and scan the IC card for authentication. This is a complex operation.

### SUMMARY

Aspects of non-limiting embodiments of the present disclosure relate to setting free a person authorized to perform a specific operation on an information processing apparatus from an authentication operation on the information processing apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: acquire image information that is obtained by photographing a person; track a movement of the person using the acquired image information; and grant a person who has stayed within a specific region for a predetermined period of time or longer an authority to perform a specific operation on an information processing apparatus, the specific region being set in advance.

### BRIEF DESCRIPTION OF THE DRAWINGS

Exemplary embodiments of the present disclosure will be described in detail based on the following figures, wherein:

FIG. 1 illustrates a system configuration of an information processing system of an exemplary embodiment of the disclosure;

FIG. 2 is a block diagram illustrating a hardware configuration of a system server of the exemplary embodiment of the disclosure;

FIG. 3 is a block diagram illustrating a functional configuration of the system server of the exemplary embodiment of the disclosure;

FIG. 4 illustrates an example of a data structure stored on a data storage of the system server;

FIG. 5 is a block diagram illustrating a hardware configuration of an image forming apparatus of the exemplary embodiment of the disclosure;

FIG. 6 is a block diagram illustrating a functional configuration of the image forming apparatus of the exemplary embodiment of the disclosure;

FIG. 7 is a flowchart illustrating a process flow of the system server;

FIG. 8 is a flowchart illustrating a process flow of the image forming apparatus;

FIG. 9 illustrates an example of a menu screen displayed on a user interface (UI) device of the image forming apparatus;

FIG. 10 illustrates an example of an operation menu in an employee mode displayed on the UI device of the image forming apparatus;

FIG. 11 illustrates an example of a log verification screen displayed on the UI device of the image forming apparatus;

FIG. 12 illustrates an example of a network status verification screen displayed on the UI device of the image forming apparatus;

FIG. 13 illustrates an example of a consumable item verification and volume setting screen displayed on the UI device of the image forming apparatus; and

FIG. 14 illustrates an example of an error screen displayed on the UI device of the image forming apparatus.

### DETAILED DESCRIPTION

### First Exemplary Embodiment

Embodiments of the disclosure are described in detail with reference to the drawings.

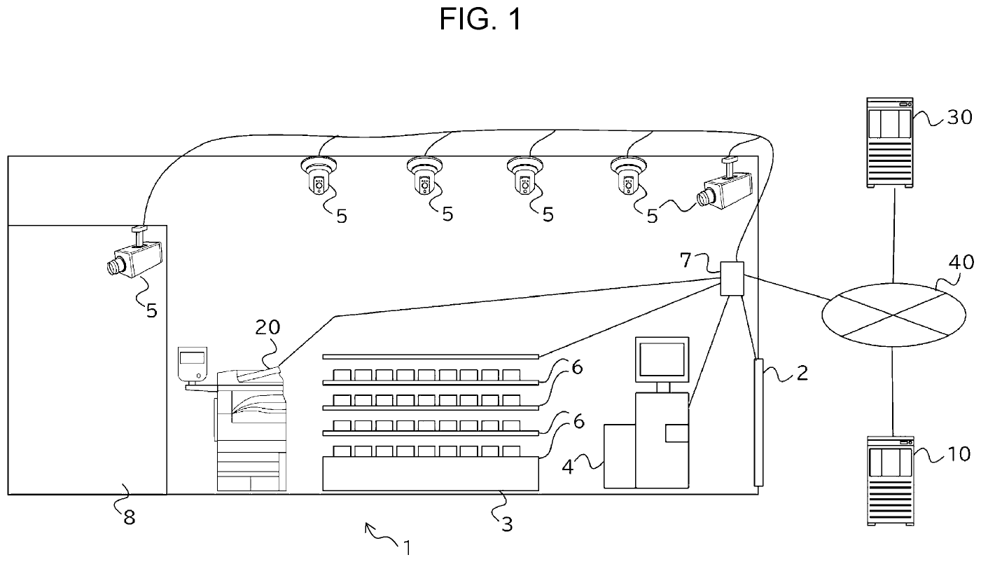

FIG. 1 illustrates a system configuration of an information processing system of a first exemplary embodiment of the disclosure.

An unmanned payment store 1 includes a gate 2 serving a doorway used by users, display shelves 3 that display items, a payment terminal device 4 that makes a payment on the prices for results related to items and services used, and cameras 5 serving imaging devices. The display shelves 3 include multiple sensors 6 that detect an item that has been taken out. The sensor 6 may be a weight sensor. The unmanned payment store 1 is an imaging space that serves as a target to be imaged by the camera 5 and an image forming apparatus 20 described below is installed in the unmanned payment store 1.

A specific region, as a backyard 8, is set beforehand in the unmanned payment store 1 and only the employees are permitted to enter the specific region.

In the information processing system of the first exemplary embodiment of the disclosure, the gate 2, payment terminal 4, multiple cameras 5, multiple sensors 6 and image forming apparatus 20 are respectively connected to a router 7. The router 7, system server 10 and billing server 30 are interconnected to each other via the Internet 40.

The system server 10 is a system management apparatus that manages information on users who enter or leave the unmanned payment store 1 and information on the items and usage of services available in the unmanned payment store 1.

The image forming apparatus 20 is an example of a service providing apparatus that provides service in the unmanned payment store 1. The image forming apparatus 20 is a multi-function apparatus that performs a print function using a paper sheet, such as a plain paper sheet and photo paper sheet, scan function, copy function, and fax function. The image forming apparatus 20 is configured such that a user may use the copy function, scan function, print function or fax function.

The billing server 30 is a billing and management apparatus that performs a calculation operation that calculates on a per user basis a price of an item or a price for service available on the image forming apparatus 20 and used by the user.

When a user enters the gate 2 of the unmanned payment store 1 having the image forming apparatus 20 installed, the system server 10 acquires image information of the user imaged by multiple cameras 5 and keeps track of the movement of the user in the unmanned payment store 1 in accordance with the acquired image information until the user leaves the unmanned payment store 1. The system server 10 acquires, from the sensors 6 and cameras 5, information on items picked up by the user for purchase (hereinafter referred to as “items to purchase”). The system server 10 acquires from the image forming apparatus 20 information on the service of the image forming apparatus 20 used by the user.

Specifically, using the cameras 5, sensors 6 and image forming apparatus 20, the system server 10 recognizes on a real-time basis the information on which an item to purchase picked up by a user and information on a service of the image forming apparatus 20 used by the user. The system server 10 transmits to the billing server 30 the information on the items to purchase and the usage of the service.

For example, a user A may have used the copy service on the image forming apparatus 20. The image forming apparatus 20 transmits to the system server 10 information on print contents, for example, the number of copied paper sheets, type of the paper sheets and size of the paper sheets. In accordance with the information acquired by the cameras 5, the system server 10 identifies the user who has used the copy service and associates the user with the information on the number of copied paper sheets, type of the paper sheets and size of the paper sheets acquired from the image forming apparatus 20. The system server 10 then transmits the information to the billing server 30.

The billing server 30 receives from the system server 10 the information on the service used on the image forming apparatus 20 and performs on a per user basis an accounting operation that calculates the prices for the services. If the user holds an item for purchase, the billing server 30 calculates a billing amount by adding the price for the item.

The billing server 30 notifies the system server 10 of the information on the user and the billing amount calculated in the accounting operation.

When the user holding the item to purchase or the user having used the service enters the payment area near the payment terminal device 4, the payment terminal device 4 acquires the billing amount from the system server 10 and displays the item to purchase, contents of the usage of the service and the billing amount on a display. The user in the payment area confirms the displayed contents and makes a payment.

If the user having stayed in a specific region, such as the backyard 8 of the unmanned payment store 1, for a predetermined period of time or longer operates the image forming apparatus 20 in the employee mode, the user is free from an authentication operation.

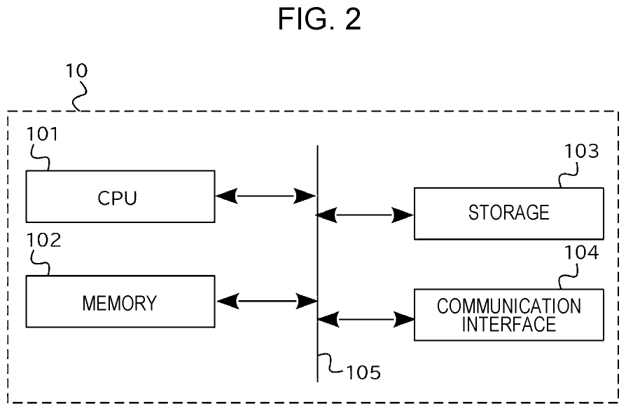

FIG. 2 illustrates a hardware configuration of the system server 10 of the information processing system described above.

Referring to FIG. 2, the system server 10 includes a central processing unit (CPU) 101, memory 102, storage 103, such as a hard disk drive (HDD), and communication interface 104. These elements are interconnected to each other via a control bus 105.

The CPU 101 is a processor that controls the process of the system server 10 by performing specific operations in accordance with a control program stored on the memory 102 or storage 103. According to the first exemplary embodiment, the CPU 101 reads and executes the control program stored on the memory 102 or the storage 103 but the disclosure is not limited to this method. The control program may be delivered in a recorded form on a computer readable recording medium. For example, the control program may be delivered in a recorded form on an optical disc, such as a compact disc read-only memory (CD-ROM) or a digital versatile disc ROM (DVD-ROM) or a semiconductor memory, such as a universal serial bus (USB) or a memory card. The control program may also be acquired from an external apparatus via the communication interface 104.

Via the Internet 40, the communication interface 104 transmits data to or receives data from each of the billing server 30, image forming apparatus 20 installed within the unmanned payment store 1, payment terminal device 4, cameras 5 and sensors 6.

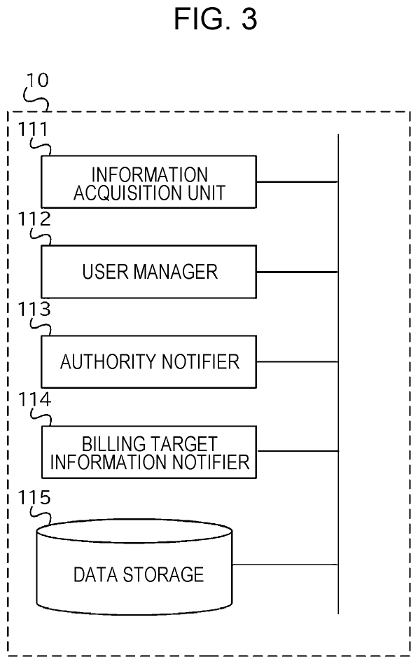

FIG. 3 is a block diagram illustrating a functional configuration of the system server 10 that is implemented by executing the control program.

Referring to FIG. 3, the system server 10 of the first exemplary embodiment functions as an information acquisition unit 111, user manager 112, authority notifier 113, billing target information notifier 114 and data storage 115.

The information acquisition unit 111 acquires image information from the cameras 5. Specifically, the information acquisition unit 111 acquires an image of a user who has entered or left the gate 2 of the unmanned payment store 1, time when the user within the unmanned payment store 1 picks up an item for purchase, the image of the user, and information on the item to purchase picked up by the user. When the user uses the image forming apparatus 20, the information acquisition unit 111 acquires the image of the user who has operated the image forming apparatus 20 and information on a used service. The information acquisition unit 111 also acquires an image of a user who has stayed within a specific region, such as the backyard 8, for a predetermined period of time.

The user manager 112 analyzes the images acquired by the information acquisition unit 111 and registers the user having entered the gate 2 as a “non-employee.” Alternatively, the user manager 112 may register the user as a “customer.” The user manager 112 analyzes the image acquired by the information acquisition unit 111 and registers the user having entered the gate 2 as a “non-employee.” Alternatively, the user manager 112 may register the user as a “customer.” The user manager 112 associates information on the item to purchase of the user acquired by the information acquisition unit 111 with the image of the user by analyzing the image of the user and registers the user and the item to purchase carried by the user on the data storage 115. The user manager 112 also associates the image of the user having used the service of the image forming apparatus 20 with the information on the used service and then registers the user and the service used by the user on the data storage 115.

The user manager 112 grants an authority to perform a specific operation on the image forming apparatus 20 to a user who has stayed within a specific region predetermined in the unmanned payment store 1, such as within the backyard 8, for a predetermined period of time or longer. The phrase “has stayed for the predetermined period of time or longer” includes passing through the specific region. The specific operation is described in detail below. The specific operation is a control operation in the employee mode to which general users as non-employees have no access. For example, the specific operation may include verifying a usage log, verifying a network status, verifying consumable items, performing volume control of the UI device 205 or verifying license information. The user manager 112 identifies a user who has stayed in the backyard 8 for the predetermined period of time or longer as an “employee” and updates information on the person on the data storage 115 from “non-employee” to “employee.”

The user manager 112 analyzes the image acquired by the information acquisition unit 111 and deletes from the data storage 115 the information on the user who has left through the gate 2.

When the image forming apparatus 20 inquires of a person operating the image forming apparatus 20, the authority notifier 113 notifies the image forming apparatus 20 whether the person is an employee.

The billing target information notifier 114 transmits to the billing server 30 the information on the user stored on the data storage 115, the information on the item to purchase of the user and the information on the used service. The billing target information notifier 114 transmits to the payment terminal device 4 information in a billing amount acquired from the billing server 30.

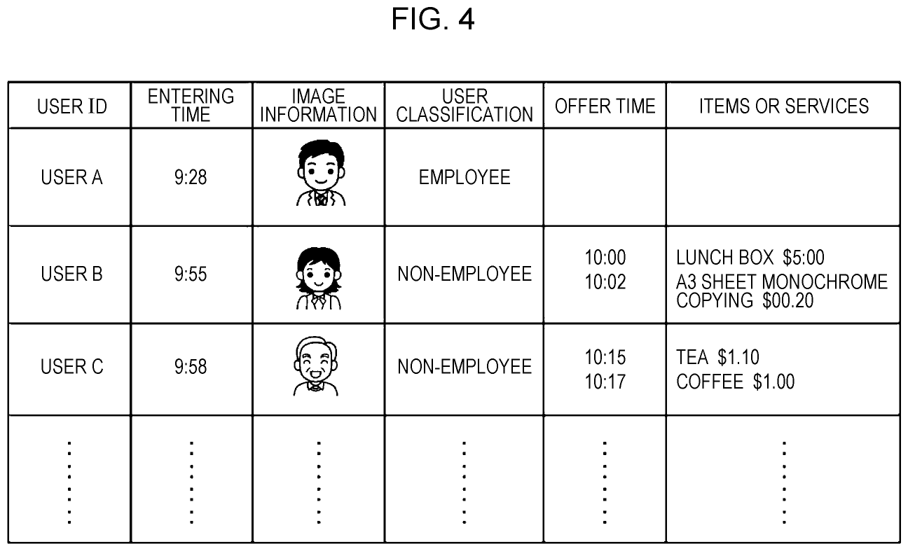

The data storage 115 stores a monitoring target list illustrated in FIG. 4. The monitoring target list lists a user identity (ID) assigned to each user having entered the unmanned payment store 1, entering time of each user, image information identifying each user, information indicating a non-employee or employee, offer time of an item and/or service and usage information on the item and/or service.

Entering time “9:28,” image information acquired with camera 5 photographing user A and user classification “employee” are stored in association with the user A. Entering time “9:55,” image information acquired with camera 5 photographing user B and user classification “non-employee” are stored in association with the user B. Offer time “10:00” of the item, usage information on the item “lunch box $5.00,” offer time of the service “10:02” and usage information on the service “A3 sheet monochrome copying $0.20” are stored in association with the user B.

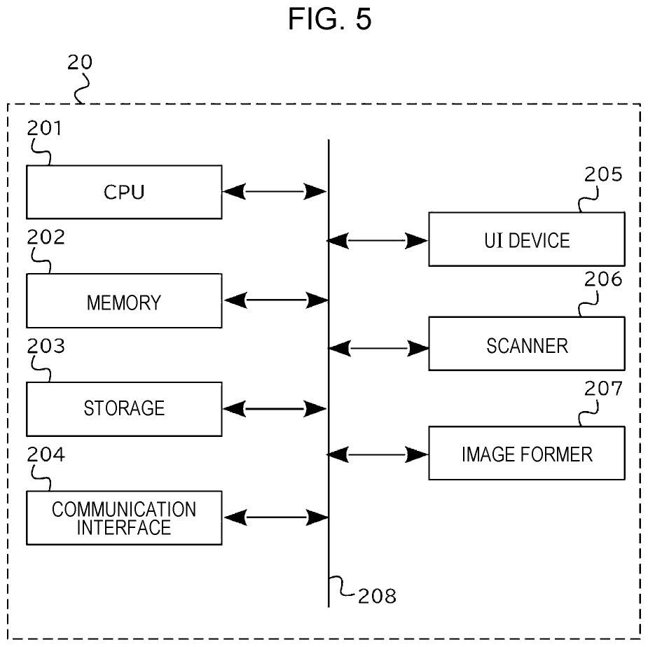

FIG. 5 illustrates the hardware configuration of the image forming apparatus 20 of the first exemplary embodiment.

Referring to FIG. 5, the image forming apparatus 20 includes a CPU 201, memory 202, storage 203, such as a HDD, communication interface 204, UI device 205, such as a touch panel, scanner 206 and image former 207. These elements are interconnected to each other via a control bus 208.

The CPU 201 is a processor that controls the process of the image forming apparatus 20 by performing predetermined operations in accordance with a control program stored on the memory 202 or storage 203. According to the first exemplary embodiment, the CPU 201 reads the control program from the memory 202 or storage 203 and executes the control program but the disclosure is not limited to this method. The control program may be delivered in a recorded form on a computer readable recording medium. For example, the control program may be delivered in a recorded form on an optical disc, such as a CD-ROM or a DVD-ROM or a semiconductor memory, such as a (USB or a memory card. The control program may also be acquired from an external apparatus via the communication interface 204.

The communication interface 204 exchanges data with the system server 10, billing server 30 or other external apparatuses via the Internet 40.

The UI device 205 includes a display that displays a variety of information to a user and an input device that receives a variety of operations from the user on the image forming apparatus 20. According to the first exemplary embodiment, the UI device 205 includes but is not limited a touch panel.

The scanner 206 reads a document image from a set document and stores temporarily the document image as the image data on the memory 202 or stores the document image on the storage 203.

The image former 207 outputs the image data temporarily stored on the memory 202 or the image data stored on the storage 203 as an image on a printed material, such as a print paper sheet. The image former 207 may also output image data acquired from the Internet 40 as an image on a printed material, such as a print paper sheet.

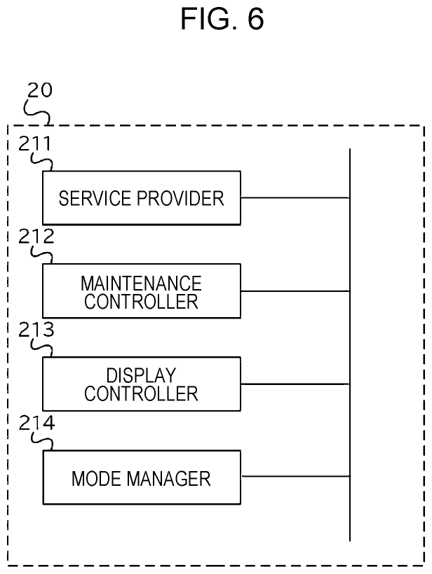

FIG. 6 is a block diagram illustrating the functional configuration of the image forming apparatus 20 that is implemented by executing the control program.

Referring to FIG. 6, the image forming apparatus 20 of the first exemplary embodiment includes a service provider 211, maintenance controller 212, display controller 213 and mode manager 214.

In response to an input operation of the user on the UI device 205, the service provider 211 performs service operations including copying a set document, scanning the document and/or printing image data acquired from the Internet.

The maintenance controller 212 performs control in the employee mode related to management and/or setting in response to the input operation of the user as an employee on the UI device 205. General users as non-employees are not permitted to perform control in the employee mode. Specifically, the control include verifying a usage log, verifying a network status, verifying consumable items, performing volume control of the UI device 205 and verifying the license information. The control further include operations related to maintenance, such as modifying hue, correcting gradation and verifying a chart.

The display controller 213 generates and displays an operation menu screen to be displayed on the UI device 205 when a user uses a service of the image forming apparatus 20. If a user not registered as an employee attempts to modify the settings on the image forming apparatus 20, the display controller 213 generates and displays an error screen.

When a user operates in the employee mode, the mode manager 214 places a request for information about the user operating the system server 10.

If information that the user is an employee is acquired from the system server 10, the mode manager 214 permits an operation in the employee mode to be performed and instructs the display controller 213 to display an operation menu in the employee mode. On the other hand, if information that the user is a non-employee is acquired from the system server 10, the mode manager 214 does not permit the operation in the employee mode to be performed and instructs the display controller 213 to display the error screen.

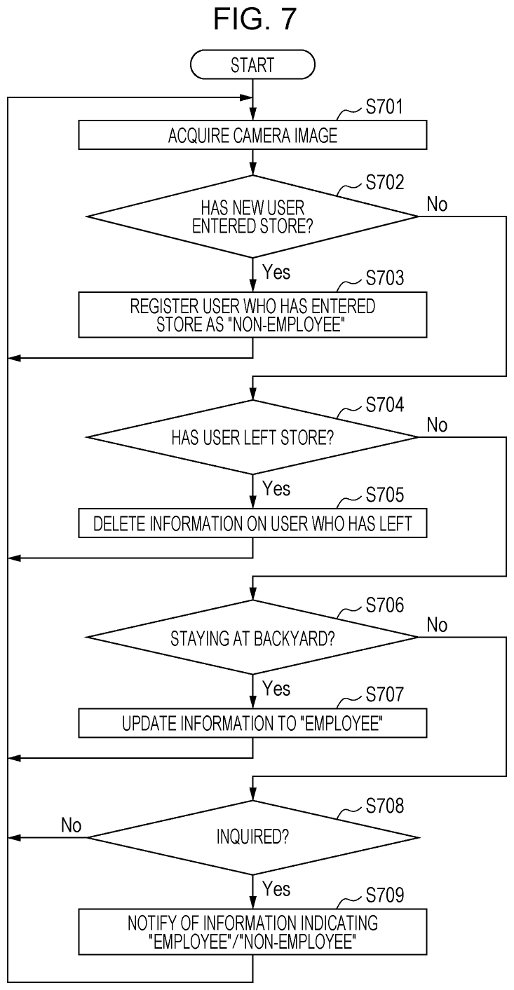

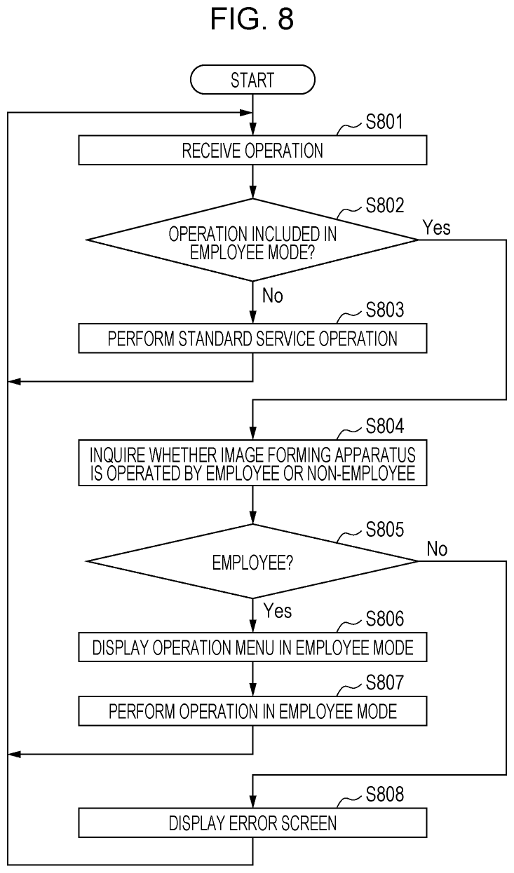

The process flow performed with the user using the image forming apparatus 20 in the information processing system thus constructed is described with reference to FIGS. 7 and 8. FIG. 7 is a flowchart illustrating the process flow of the system server 10. In the following discussion, a billing operation is not closely relevant to the disclosure and the discussion thereof is omitted herein.

In step S701 in FIG. 7, the information acquisition unit 111 in the system server 10 acquires image information from the cameras 5 installed in the unmanned payment store 1.

In step S702, the user manager 112 analyzes an image acquired by the information acquisition unit 111 and determines whether a new user has entered the gate 2. If the user manager 112 determines that a new user has entered the gate 2, processing proceeds to step S703. In step S703, the user manager 112 sets the new user to be a “user A” and registers the entering time, face photo serving as image information identifying the user A and information indicating that the user is a non-employee in an associated form in the data storage 115. Processing returns to step S701.

If the user manager 112 determines in step S702 that any new user has not entered the unmanned payment store 1, processing proceeds to step S704. In step S704, the user manager 112 determines whether a user has left the unmanned payment store 1 via the gate 2. If the user manager 112 determines that a user has left the unmanned payment store 1 via the gate 2, processing proceeds to step S705. In step S705, the user manager 112 identifies the user who has left the unmanned payment store 1 and if the user is the user A, the user manager 112 deletes information related to the user A from the data storage 115 and returns to step S701.

If the user manager 112 determines in step S704 that the user has not left the unmanned payment store 1, processing proceeds to step S706. In step S706, the user manager 112 determines whether the user has stayed within a specific region set in the unmanned payment store 1, for example, within the backyard 8 for a predetermined period of time or longer. For example, the predetermined period of time is 30 seconds. If the user manager 112 determines that the user has stayed within the backyard 8 for the predetermined period of time or longer, processing proceeds to step S707. In step S707, the user manager 112 identifies the user having stayed within the backyard 8. If the user is the user A, the user manager 112 updates information on the non-employee associated with the user to “employee.” Processing returns to step S701. Since the user A having entered at 9:28 has stayed within the backyard 8 for the predetermined period of time or longer in FIG. 4, the user manager 112 updates the information on the non-employee to the information on the employee.

If the user manager 112 determines in step S706 that the user has not stayed within the backyard 8 for the predetermined period of time or longer, processing proceeds to step S708. In step S708, the authority notifier 113 determines whether the image forming apparatus 20 has inquired of the user operating the image forming apparatus 20. If the authority notifier 113 determines that the system server 10 has inquired, processing proceeds to step S709.

In step S709, the information acquisition unit 111 acquires from the camera 5 the image of the user operating the image forming apparatus 20. By referencing the data on the data storage 115, the authority notifier 113 determines whether the user corresponding to the acquired image of the user is a non-employee or employee and notifies the image forming apparatus 20 of the determination results. For example, if the user A in FIG. 4 operates the image forming apparatus 20, the information acquisition unit 111 determines that the user A is an employee and notifies the image forming apparatus 20 that the user A is an employee. Processing returns to step S701.

If the authority notifier 113 determines in step S708 that the image forming apparatus 20 has not inquired, processing returns to step S701 and the operations described above are performed.

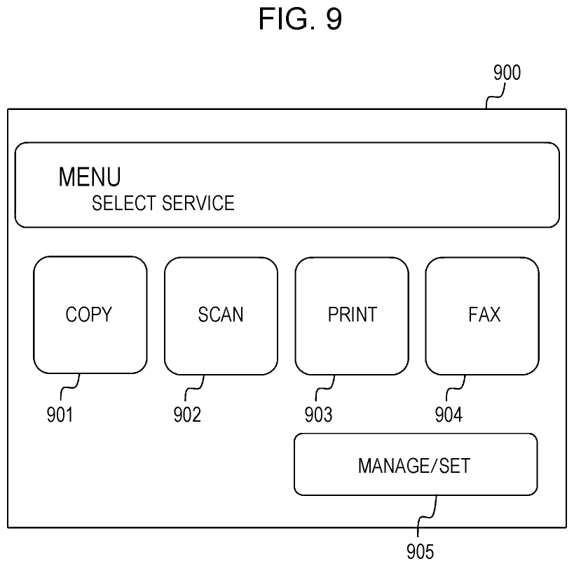

FIG. 8 is a flowchart illustrating the process flow of the image forming apparatus 20. In step S801 in FIG. 8, the display controller 213 displays a menu screen on the UI device 205 in the image forming apparatus 20 and receives an operation of the user. For example, the display controller 213 causes the UI device 205 to display a menu screen 900 in FIG. 9. The menu screen 900 includes a copy icon 901, scan icon 902, print icon 903, fax icon 904 and manage/set icon 905. The user performs a desired operation while viewing the menu screen 900.

In step S802, the mode manager 214 determines whether an operation of the user is an operation in the employee mode. If the mode manager 214 determines that the operation of the user is not an operation in the employee mode, in other words, the operation of the user is an operation for standard services, such as copy, scan, print and fax, processing proceeds to step S803.

In step S803, in response to an input operation of the user on the UI device 205, the service provider 211 performs one of the standard service operations including copying a set document, scanning the document and printing image data acquired from the Internet. If a standard service operation is performed, the image forming apparatus 20 transmits to the system server 10 information on the service, such as information on print contents, including the number of, type of and size of copy paper sheets. This operation is not closely relevant to the disclosure and further discussion thereof is thus omitted herein. When the standard service operation is complete, processing returns to step S801.

If the mode manager 214 determines in step S802 that the operation of the user is an operation included in the employee mode, processing proceeds to step S804. In other words, if the user selects the manage/set icon 905 on the menu screen 900 in FIG. 9, processing proceeds to step S804.

In step S804, the mode manager 214 makes an inquiry to the system server 10.

Specifically, the mode manager 214 inquires of the system server 10 as to whether the user operating the image forming apparatus 20 is a non-employee or employee.

In step S805, the mode manager 214 receives a reply to the inquiry from the system server 10 and determines whether the user operating the image forming apparatus 20 is an employee or non-employee. If it is determined that the user is an employee, processing proceeds to step S806.

In step S806, the mode manager 214 permits the maintenance controller 212 to perform an operation and instructs the display controller 213 to display an operation menu in the employee mode. Specifically, if the user as an employee who has stayed within the backyard 8 for the predetermined period of time or longer attempts to operate in the employee mode, the user is not requested to perform an authentication operation and the operation menu in the employee mode is displayed. In step S807, the maintenance controller 212 performs maintenance and setting modification on the image forming apparatus 20 in response to the input operation of the user as the employee on the UI device 205.

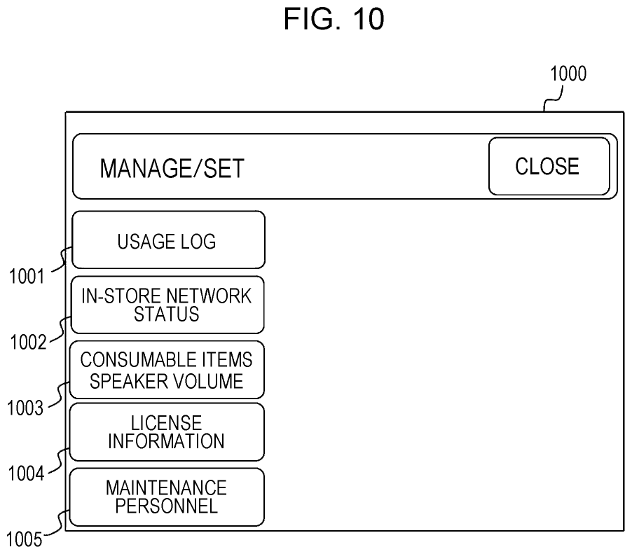

FIG. 10 illustrates an example of the operation menu in the employee mode displayed on the UI device 205. The operation menu in the employee mode includes a manage/set screen 1000 illustrated in FIG. 10. The manage/set screen 1000 includes a usage log icon 1001, in-store network icon 1002, consumable items and speaker volume icon 1003, license information icon 1004 and maintenance personnel icon 1005. The user as an employee operates the UI device 205 while viewing the manage/set screen 1000 and thus performs maintenance and setting modification on the image forming apparatus 20. When the maintenance and setting modification are complete, processing returns to step S801.

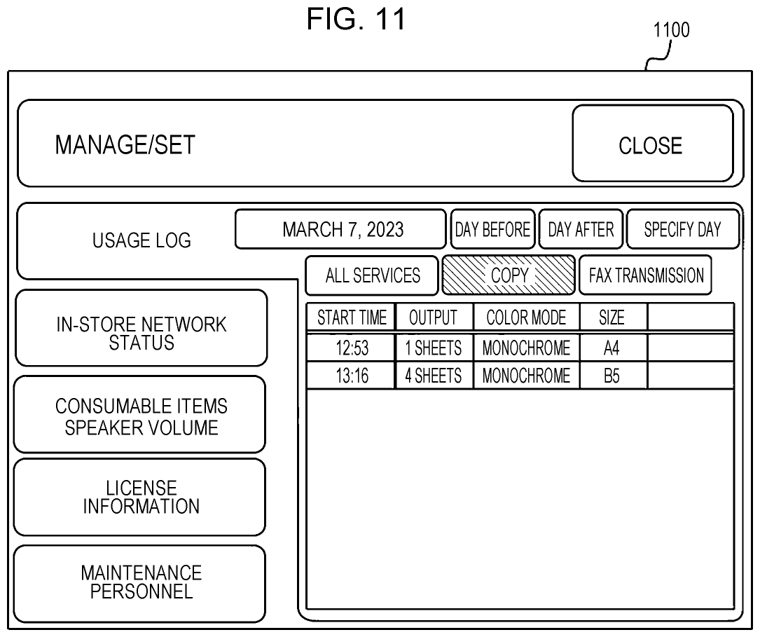

When the user as the employee selects the usage log icon 1001, the maintenance controller 212 instructs the display controller 213 to display a log verification screen 1100 in FIG. 11 on the UI device 205. The log verification screen 1100 displays information on a service on the day of interest when the image forming apparatus 20 provides the service. By operating the log verification screen 1100, the user may display usage log of service on the previous day and the following day or usage log service on any day by specifying the day.

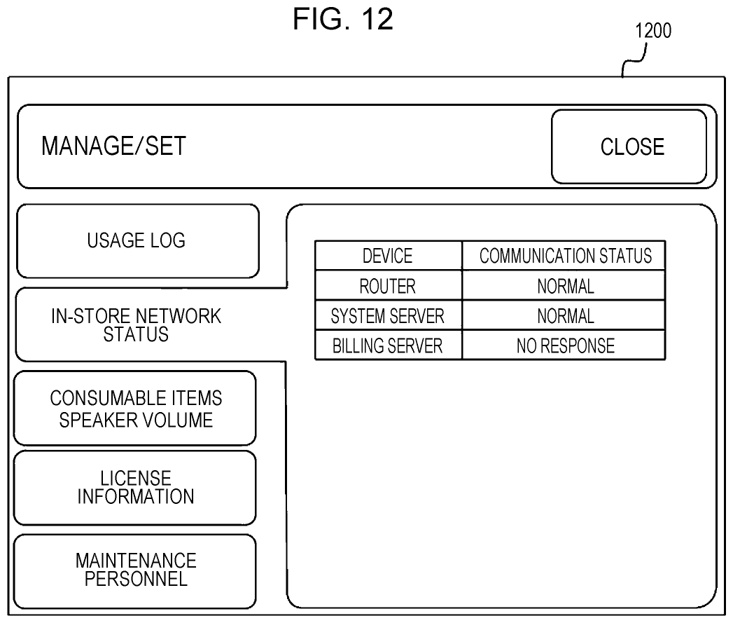

If the in-store network icon 1002 is selected on the manage/set screen 1000 in FIG. 10, the maintenance controller 212 instructs the display controller 213 to display a network status verification screen 1200 in FIG. 12 on the UI device 205. The network status verification screen 1200 displays communication status of each of the router 7, system server 10 the billing server 30 communicating with the image forming apparatus 20 as “normal” or “no response.”

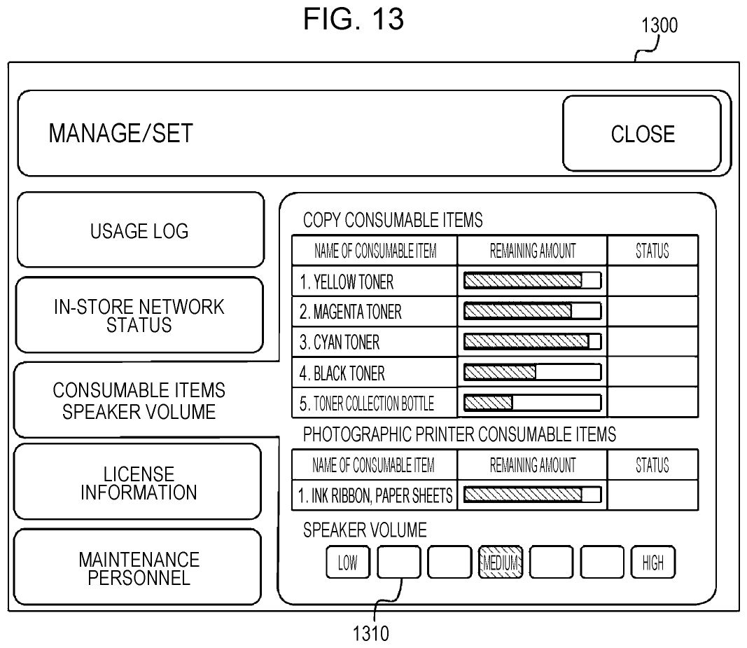

When the consumable items and speaker volume icon 1003 is selected on the manage/set screen 1000 in FIG. 10, the maintenance controller 212 instructs the display controller 213 to display the consumable item verification and volume setting screen 1300 in FIG. 13 on the UI device 205. The consumable item verification and volume setting screen 1300 displays information on a remaining amount of toner and remaining amount of ink as consumable items of the image forming apparatus 20. The consumable item verification and volume setting screen 1300 includes a volume setting screen 1310 and the user as an employee operates the UI device 205 while viewing the volume setting screen 1310 to control the volume of the image forming apparatus 20.

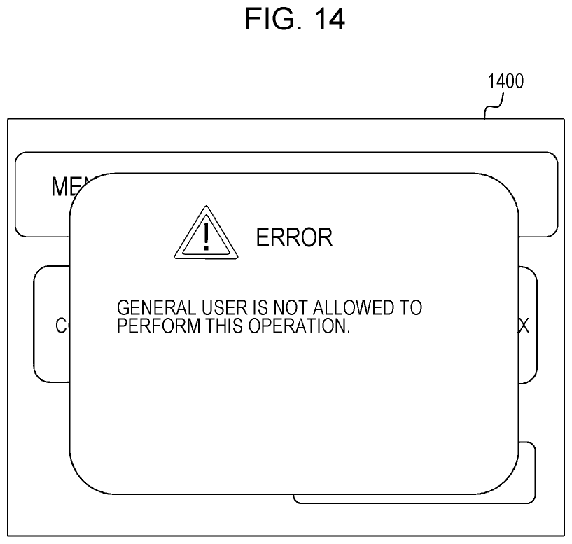

If the mode manager 214 determines in step S805 in FIG. 8 that the user operating the image forming apparatus 20 is not an employee, processing proceeds to step S808. In step S808, the mode manager 214 does not permit an operation in the employee mode and instructs the display controller 213 to display the error screen 1400 in FIG. 14 on the UI device 205.

Referring to FIG. 14, the error screen 1400 does not display a message reading “General user is not permitted to perform this operation.” After displaying the error screen 1400 on the UI device 205 for a predetermined period of time, for example, several seconds, the display controller 213 returns to step S801.

According to the first exemplary embodiment, if the user who has stayed within the backyard 8 for the predetermined period of time or longer performs an operation in the employee mode, an operation in the employee mode from the user is accepted without the user being requested to perform the authentication operation.

According to the first exemplary embodiment, if the user determined as a non-employee performs an operation in the employee mode, the error screen is displayed. The disclosure is not limited to this method. In place of causing the display controller 213 to display the error screen, the mode manager 214 displays an authentication screen used to authenticate the user as an employee and if the user is correctly authenticated, an operation in the employee mode may be permitted. Specifically, if the user as a non-employee who has not stayed within the backyard 8 for the predetermined period of time or longer performs an operation in the employee mode, that user is requested to perform the authentication operation. In the authentication operation, the user may be authenticated to be an employee by using integrated circuit (IC) card authentication or by inputting a combination of ID and password.

According to the first exemplary embodiment, when the image forming apparatus 20 inquires of the authority notifier 113 in the system server 10 as to whether the person operating the image forming apparatus 20 is an employee or non-employee, the authority notifier 113 notifies the image forming apparatus 20 of the answer to the inquiry. The disclosure is not limited to the first exemplary embodiment. When a person starts operating the image forming apparatus 20, the authority notifier 113 in the system server 10 may actively notify the image forming apparatus 20 in accordance with information on the data storage 115 whether the person operating the image forming apparatus 20 is an employee or non-employee.

If the user as an employee selects the manage/set icon 905 on the menu screen 900 in FIG. 9, the manage/set screen 1000 in FIG. 10 is displayed on the UI device 205 without the user being requested to perform the authentication operation and the user performs the maintenance or setting modification. On the other hand, if the user as a non-employee selects the manage/set icon 905 on the menu screen 900 in FIG. 9, the error screen 1400 in FIG. 14 is displayed such that the user as the non-employee is unable to perform the maintenance or setting modification.

If the information acquisition unit 111 is notified by the image forming apparatus 20 that a user registered as an employee on the data storage 115 is going to perform or has performed a specific operation, namely, an unauthorized operation, an operation described below may be performed. If the user manager 112 determines in accordance with the image data acquired by the information acquisition unit 111 that a user registered as an employee on the data storage 115 has taken a predetermined action, an operation described below may be performed

Specifically, the user manager 112 modifies information registered as employee on the data storage 115 to “non-employee” and notifies the image forming apparatus 20 that the information has been modified to non-employee. In other words, an operation authority in the employee mode imparted to the user is revoked. In response to this notification, the mode manager 214 in the image forming apparatus 20 displays the error image on the display controller 213, thus instructing the display controller 213 to display an indication that an operation in the employee mode is difficult to perform because of a violation. The mode manager 214 causes the user to be unable to operate in the employee mode.

Upon receiving the notification, the mode manager 214 may restrict at least some of the operations in the employee mode and permit other operations to be performed.

### Second Exemplary Embodiment

In an information processing system of a second exemplary embodiment, in addition to the configuration of the first exemplary embodiment, a user considered as an employee who has been successfully authenticated on the image forming apparatus 20 may be authorized to access to a wider range of the operation authority than the employee mode. The configuration of the system server 10 and image forming apparatus 20 forming the information processing system of the second exemplary embodiment is basically identical to the configuration of the first exemplary embodiment and like elements are designated with like reference numerals.

According to the second exemplary embodiment, the image forming apparatus 20 has a first employee mode in which the user has access to a first operation authority that includes verifying the usage log, verifying the in-house network status, verifying the consumable items and speaker volume and verifying license information. In addition, the image forming apparatus 20 has a second employee mode in which the user has access to a second operation authority for machine operator. The second operation authority includes modifying hue, correcting gradation, verifying a chart, adjusting the position of an output image and adjusting the density of the output image. The operations in the second employee mode includes operations different from the operations in the first employee mode.

When the mode manager 214 acquires from the system server 10 information that the user operating the image forming apparatus 20 is an employee, the mode manager 214 permits the operations in the first employee mode to be performed and instructs the display controller 213 to display an operation menu in the first employee mode. The operation menu in the first employee mode is, for example, identical to the manage/set screen 1000 described with reference to the first exemplary embodiment in FIG. 10.

When an employee performs an operation in the second employee mode, the mode manager 214 requests the employee to perform the authentication operation. Specifically, if the user as an employee selects the maintenance personnel icon 1005 on the manage/set screen 1000 in FIG. 10, the mode manager 214 instructs the display controller 213 to display on the UI device 205 an authentication request screen that prompts the ID and password to be entered. The authentication is not limited to the above described method. For example, an IC card reader may be arranged on the image forming apparatus 20 and the authentication may be performed using an IC card. Alternatively, a camera may be arranged on the image forming apparatus 20 and the authentication may be performed by checking a face image photographed by the camera with a pre-registered image. The mode manager 214 makes an inquiry to the system server 10 and then authenticates whether the user as an employee is to be authorized to have access to the second operation authority.

In response to the authentication, the authority notifier 113 in the system server 10 notifies the image forming apparatus 20 of the authentication results. Specifically, the authority notifier 113 notifies the image forming apparatus 20 whether the authenticated user is to be authorized to have the second operation authority. If the user is successfully authenticated, the mode manager 214 permits an operation in the second employee mode to be performed and instructs the display controller 213 to display the operation menu in the second employee mode. The operation menu is used for the machine operator to modify hue, correct gradation, verify a chart, adjust the position of an output image and adjust the density of the output image. The user performs an operation in the second employee mode while operating the UI device 205 and viewing the operation menu in the second employee mode. If the user is not successfully authenticated, the mode manager 214 does not permit an operation in the second employee mode to be performed and instructs the display controller 213 to display the error image.

If an authentication device is installed at a gateway of the backyard 8 within the unmanned payment store 1 and an employee enters the backyard 8, a first authentication method is performed using an IC card. On the other hand, if an operation in the second employee mode of the image forming apparatus 20 is performed, a second authentication method different from the first authentication method may be performed using an ID and password. In such a case, the system server 10 manages information about whether the user has been successfully authenticated or not and if the user is successfully authenticated in the first authentication method, the first operation authority is granted to the user. If the user is successfully authenticated in the second authentication method, the second operation authority is granted to the user.

If a user having entered the backyard 8 in the unmanned payment store 1 is registered as an employee and the user uses the image forming apparatus 20, the user may perform an operation in the employee mode without being requested to perform the authentication operation. According to the exemplary embodiments, the image forming apparatus 20 is an information processing apparatus. The disclosure is not limited to this configuration. The disclosure may be applied to an apparatus and an entire system in which a specific operation is available through authorization. The disclosure may be applied to the payment terminal device 4 as a self checkout instead of the image forming apparatus 20. A non-employee as a general user may be permitted to use a standard function of the self checkout but a user who is considered as an employee by entering the backyard 8 may perform a specific operation of the self checkout in a manner free from the authentication operation.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the e embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system including:
a processor configured to:
   acquire image information that is obtained by photographing a person;
   track a movement of the person using the acquired image information; and
   grant a person who has stayed within a specific region for a predetermined period of time or longer an authority to perform a specific operation on an information processing apparatus, the specific region being set in advance.
      (((2)))

In the information processing system according (((1))), the authority to perform the specific operation is a first operation authority, and if the person who has been granted the first operation authority is successfully authenticated in a predetermined authentication method, the person is further granted a second operation authority that includes an authority to perform an operation different from the specific operation.

(((3)))

In the information processing system according to (((2))), the processor is configured to grant the person having the first operation authority the second operation authority if the person having the first operation authority is successfully authenticated in a second authentication method different from the first authentication method to enter the specific region.

(((4)))

In the information processing system according to (((1))), the processor is configured to:
if a person who has not stayed in the specific region for the predetermined period of time or longer performs the specific operation on the information processing apparatus, request the person who has not stayed in the specific region for the predetermined period of time or longer to perform an authentication operation; and
if a person who has stayed in the specific region for the predetermined period of time or longer performs the specific operation on the information processing apparatus, not request the person who has stayed in the specific region for the predetermined period of time or longer to perform the authentication operation.
   (((5)))

In the information processing system according to (((1))), if the person having the authority to perform the specific operation on the information processing apparatus has performed a predetermined operation on the information processing apparatus or has took a predetermined action, at least part of the authority to perform the specific operation on the information processing apparatus is restricted.

(((6)))

In the information processing system according to (((5))), if the person having the authority to perform the specific operation on the information processing apparatus has performed the predetermined operation on the information processing apparatus or has took the predetermined action, the authority to perform the specific operation on the information processing apparatus is revoked.

(((7)))

In the information processing system according to one of (((1))) through (((6))), the information processing apparatus is an image forming apparatus.

(((8)))

A program causing a computer to execute a process, the process including:
acquiring image information that is obtained by photographing a person;
tracking a movement of the person using the acquired image information; and
granting a person who has stayed within a specific region for a predetermined period of time or longer an authority to perform a specific operation on an information processing apparatus, the specific region being set in advance.

What is claimed is:

1. An information processing system comprising:
a processor configured to:
acquire image information that is obtained by photographing a person;
track a movement of the person using the acquired image information; and
grant a person who has stayed within a specific region for a predetermined period of time or longer an authority to perform a specific operation on an information processing apparatus, the specific region being set in advance.

2. The information processing system according to claim 1, wherein the authority to perform the specific operation is a first operation authority, and wherein if the person who has been granted the first operation authority is successfully authenticated in a predetermined authentication method, the person is further granted a second operation authority that includes an authority to perform an operation different from the specific operation.

3. The information processing system according to claim 2, wherein the processor is configured to grant the person having the first operation authority the second operation authority if the person having the first operation authority is successfully authenticated in a second authentication method different from the first authentication method to enter the specific region.

4. The information processing system according to claim 1, wherein the processor is configured to:
if a person who has not stayed in the specific region for the predetermined period of time or longer performs the specific operation on the information processing apparatus, request the person who has not stayed in the specific region for the predetermined period of time or longer to perform an authentication operation; and
if the person who has stayed in the specific region for the predetermined period of time or longer performs the specific operation on the information processing apparatus, not request the person who has stayed in the specific region for the predetermined period of time or longer to perform the authentication operation.

5. The information processing system according to claim 1, wherein if the person having the authority to perform the specific operation on the information processing apparatus has performed a predetermined operation on the information processing apparatus or has took a predetermined action, at least part of the authority to perform the specific operation on the information processing apparatus is restricted.

6. The information processing system according to claim 5, wherein if the person having the authority to perform the specific operation on the information processing apparatus has performed the predetermined operation on the information processing apparatus or has took the predetermined action, the authority to perform the specific operation on the information processing apparatus is revoked.

7. The information processing system according to claim 1, wherein the information processing apparatus is an image forming apparatus.

8. The information processing system according to claim 2, wherein the information processing apparatus is an image forming apparatus.

9. The information processing system according to claim 3, wherein the information processing apparatus is an image forming apparatus.

10. The information processing system according to claim 4, wherein the information processing apparatus is an image forming apparatus.

11. The information processing system according to claim 5, wherein the information processing apparatus is an image forming apparatus.

12. The information processing system according to claim 6, wherein the information processing apparatus is an image forming apparatus.

13. A non-transitory computer readable medium storing a program causing a computer to execute a process, the process comprising:
acquiring image information that is obtained by photographing a person;
tracking a movement of the person using the acquired image information; and
granting a person who has stayed within a specific region for a predetermined period of time or longer an authority to perform a specific operation on an information processing apparatus, the specific region being set in advance.

14. An information processing method comprising:
acquiring image information that is obtained by photographing a person;
tracking a movement of the person using the acquired image information; and
granting a person who has stayed within a specific region for a predetermined period of time or longer an authority to perform a specific operation on an information processing apparatus, the specific region being set in advance.
